(19) United States
(12) Patent Application Publication
(10) Pub. No.: US 2020/0290384 A1
(43) Pub. Date: Sep. 17, 2020

(54) INKJET RECORDING DEVICE

(71) Applicant: Konica Minolta, Inc., Tokyo (JP)

(72) Inventors: Masakazu DATE, Hino-shi, Tokyo (JP); Toshiyuki Mizutani, Hino-shi, Tokyo (JP)

(21) Appl. No.: 16/084,134

(22) PCT Filed: Mar. 8, 2017
(86) PCT No.: PCT/JP2017/009139

§ 371 Date: Sep. 11, 2018

(30) Foreign Application Priority Data
Mar. 28, 2016 (JP) 2016 063756

(51) Int. Cl. B41J 29/393

(52) U.S. Cl. CPC B41J 29/393; B41J 2029/3935

(57) ABSTRACT

An inkjet recording device includes: an image former; an image reader including a line sensor and an optical unit; and a conveyor. The line sensor has imaging elements, and detects incident light from a surface of a recording medium over an imaging range corresponding to arrangement of the imaging elements in a width direction intersecting a relative movement direction in which the recording medium and/or the image reader is relatively moved, thereby performing one-dimensional imaging along the width direction. The optical unit removes a high-frequency-side component that is a spatial structure equal to or higher than a predetermined cutoff frequency from spatial distribution of the incident light from the imaging range and guides the incident light to the line sensor. The cutoff frequency for the high-frequency-side component is determined to be lower in the width direction than the relative movement direction.

### TECHNICAL FIELD

The present invention relates to an inkjet recording device.

### BACKGROUND ART

There is a conventional inkjet recording device which forms images by discharging ink from a plurality of nozzles. Nowadays, with demands on speedup and accuracy increase in image forming, the number of nozzles has being increasing. There is also an inkjet recording device using a line head(s) which performs image forming at high speed by forming images while conveying recording media in a predetermined conveyance direction without moving nozzles arranged to cover the width of the recording media.

Inkjet recording devices need to discharge ink from each of nozzles normally. Even if ink is discharged from each of nozzles normally, variation in, for example, drive units which drive loads for discharging the ink from the nozzles needs to be adjusted. Further, if a plurality of recording heads is arranged to discharge ink from their nozzles, relative positions of the recording heads, their ink discharge speeds and so forth also need to be adjusted. To deal with these, there is an inkjet recording device having an image reading device which can image the surface of recording media, wherein the inkjet recording device causes the image reading device to read a predetermined test image formed on the surface of a recording medium, and performs various types of adjustment and detection of defective nozzles on the basis of the reading result, and also performs processes to deal with raised problems and so forth. (Refer to, for example, Patent Document 1.)

Thus, unlike a general scanner, an image reading device used in an inkjet recording device does not need to read the whole image in a well-balanced manner with high accuracy, but should be able to obtain information necessary for the adjustment and the detection. Hence, a line sensor having an arrangement interval of imaging elements or reading resolution lower than a nozzle interval of nozzles or resolution of recorded images is often used. However, if the resolution of the image reading device is lower than structures characteristic of a test image, such as an interval of strips, artificial structures, such as moire, may appear in imaging data, and accordingly necessary information may not be obtained, or misrecognition may occur. For reducing or preventing these problems, there is known a technique of lowering the resolution of reading images with an optical low-pass filter (OLPF).

### RELATED ART DOCUMENTS

### Patent Documents

Patent Document 1: Japanese Patent Application Publication No. 2015-058602

### SUMMARY OF THE INVENTION

### Problems to be Solved by the Invention

However, in the case where a line sensor is used as an image reading device, in the line sensor, the resolution in an arrangement direction of imaging elements is determined by the arrangement interval of the imaging elements, whereas in a direction which intersects the arrangement direction and is a conveyance direction of a recoding medium on which a recorded image has been formed, because of the conveyance of the recording medium, a single imaging element successively performs imaging spaces according to a conveyance speed and an imaging interval. Hence, if the resolution is decreased isotropically with an optical system which guides light that is made incident on the imaging elements, a problem arises that the resolution is decreased more than necessary and it becomes difficult to obtain necessary information.

Objects of the present invention include providing an inkjet recording device which can obtain imaging data with more appropriate resolution.

### Means for Solving the Problems

In order to achieve the above object(s), the present invention described in claim 1 is an inkjet recording device including:

a recording unit which discharges ink from a nozzle, thereby forming an image on a recording medium;

an imaging unit which images a surface of the recording medium; and

a moving unit which moves at least one of the recording medium and the imaging unit, thereby relatively moving the recoding medium and the imaging unit in a predetermined relative movement direction, wherein

the imaging unit includes:
a line sensor which has a plurality of imaging elements, and detects incident light from the surface of the recording medium over an imaging range corresponding to arrangement of the imaging elements in a width direction intersecting the relative movement direction, thereby performing one-dimensional imaging along the width direction; and
an optical unit which removes a high-frequency-side component that is a spatial structure equal to or higher than a predetermined cutoff frequency from spatial distribution of the incident light from the imaging range and guides the incident light to the line sensor, and

the cutoff frequency for the high-frequency-side component which is removed by the optical unit is determined to be lower in the width direction than the relative movement direction.

The present invention described in claim 2 is the inkjet recording device according to claim 1, wherein the optical unit removes the high-frequency-side component at an orientation along the width direction only.

The present invention described in claim 3 is the inkjet recording device according to claim 1 or 2, wherein the cutoff frequency in the width direction is equal to or lower than a Nyquist frequency corresponding to resolution of one-dimensional imaging data by the line sensor.

The present invention described in claim 4 is the inkjet recording device according to any one of claims 1 to 3, wherein the optical unit includes an optical low-pass filter which removes the high-frequency-side component.

The present invention described in claim 5 is the inkjet recording device according to claim 4, wherein the optical low-pass filter is configured such that flat crystal plates each of which performs birefringence on the incident light in the width direction are laid on top of one another.

The present invention described in claim 6 is the inkjet recording device according to claim 5, wherein a separation width between an ordinary ray and an extraordinary ray of at least one of the flat crystal plates is different from the separation width of at least another one of the flat crystal plates.

The present invention described in claim 7 is the inkjet recording device according to claim 5 or 6, wherein in the optical low-pass filter, a separation width between an ordinary ray and an extraordinary ray of, among the flat crystal plates, a flat crystal plate closest to the line sensor is smaller than the separation width of a remaining flat crystal plate.

The present invention described in claim 8 is the inkjet recording device according to claim 6 or 7, wherein the separation width is determined according to an arrangement interval of the imaging elements in the width direction.

The present invention described in claim 9 is the inkjet recording device according to any one of claims 1 to 8, wherein resolution of one-dimensional imaging data by the line sensor is determined to be smaller than recording resolution corresponding to a nozzle interval of nozzles including the nozzle in the width direction in the recording unit, and the recording resolution is determined to be a non-integral multiple of the resolution of the one-dimensional imaging data.

The present invention described in claim 10 is the inkjet recording device according to any one of claims 1 to 9, including a movement control unit which controls a relative movement speed of the relative movement by the moving unit, wherein

the movement control unit makes the relative movement speed lower in imaging a predetermined test image with the imaging unit than in forming an ordinary image.

The present invention described in claim 11 is the inkjet recording device according to claim 10, including a position information obtaining unit which obtains, based on imaging data on the test image, position information on a position at which the ink discharged from the nozzle lands on the recording medium.

The present invention described in claim 12 is the inkjet recording device according to claim 11, wherein the movement control unit sets the relative movement speed such that a relative movement distance of the imaging unit and the recoding medium in an interval between times at which the line sensor performs imaging is smaller than a length of the imaging range in the relative movement direction by each of the imaging elements of the line sensor.

The present invention described in claim 13 is the inkjet recording device according to any one of claims 4 to 8, including a filter control unit which, when causing the imaging unit to image a test image having a spatial structure cycle smaller than an arrangement interval of the imaging elements of the line sensor in the width direction, causes the optical low-pass filter to remove the predetermined high-frequency-side spatial structure from the spatial distribution of the incident light.

### Advantageous Effects of the Invention

According to the present invention, the inkjet recording device has an effect of being able to obtain imaging data with more appropriate resolution.

### BRIEF DESCRIPTION OF THE DRAWINGS

FIG. 1 is a perspective view showing the whole inkjet recording device according to an embodiment(s) of the present invention.

FIG. 2 schematically shows a positional relationship between nozzle opening parts on a surface of a head unit and an imaging area on a surface of an image reader, the surfaces facing a conveyance surface.

FIG. 3 is a block diagram showing functional configuration of the inkjet recording device.

FIG. 4 is a schematic view schematically showing internal configuration of the image reader.

FIG. 5A is a diagram to explain configuration of an OLPF.

FIG. 5B is a diagram to explain the configuration of the OLPF.

FIG. 6 is a diagram to explain image reading in a conveyance direction.

FIG. 7A shows a part of an example of a test image.

FIG. 7B shows a part of an example of the test image.

FIG. 7C shows a part of an example of the test image.

FIG. 8 is a flowchart showing a control procedure of a position adjustment process by a controller.

### EMBODIMENTS FOR CARRYING OUT THE INVENTION

Hereinafter, one or more embodiments of the present invention are described on the basis of the drawings.

FIG. 1 is a perspective view showing the whole inkjet recording device 1 according to an embodiment(s) of the present invention.

The inkjet recording device 1 includes a conveyor 10 (moving unit), an image former 20 (recording unit), an image reader 30 (imaging unit), and a controller 40 (a movement control unit, a position information obtaining unit, a filter control unit).

The conveyor 10 has a conveyor motor 11, a conveyor belt 12 and so forth, and moves, as a conveyance surface, the outer circumferential surface of the conveyor belt 12 in a predetermined conveyance direction (relative movement direction) in relation to the image former 20, thereby moving a recording medium P placed on the conveyance surface in the conveyance direction.

The image reader 30 is arranged on the downstream side of the image former 20 in the conveyance direction of the recording medium P, and images an image(s) formed on a recording surface of the recording medium P (the surface of the recording medium P) by the image former 20, and outputs the same as imaging data. The image reader 30 has, for example, a line sensor in which a plurality of imaging elements is arranged in a width direction intersecting the conveyance direction (at right angles, in this embodiment) so as to cover an ink dischargeable width by each head unit 21 on the predetermined size recording medium P. While the conveyor 10 is moving the recording medium P in the conveyance direction in relation to the image reader 30, the line sensor successively performs one-dimensional imaging in an imaging range corresponding to an ink discharge range extending in the width direction, and obtains a two-dimensional image on the recording medium P by using the obtained plurality of one-dimensional imaging data.

The controller 40 controls operations of all the components of the inkjet recording device 1.

The image former 20 performs recording operation of discharging ink from nozzles such that the ink lands on the upper face of the recording medium P, thereby forming an image(s). In this embodiment, the image former 20 has four head units 21Y, 21M, 21C, 21K (which hereinafter may be referred to as “head units 21”) which respectively discharge yellow, magenta, cyan and black inks supplied from not-shown their respective ink reservoirs. Each head unit 21 has the nozzles arranged in the width direction in a plane parallel to the conveyance surface so as to cover a recordable width of the predetermined size (the abovementioned maximum width size) recording medium P, and can discharge ink.

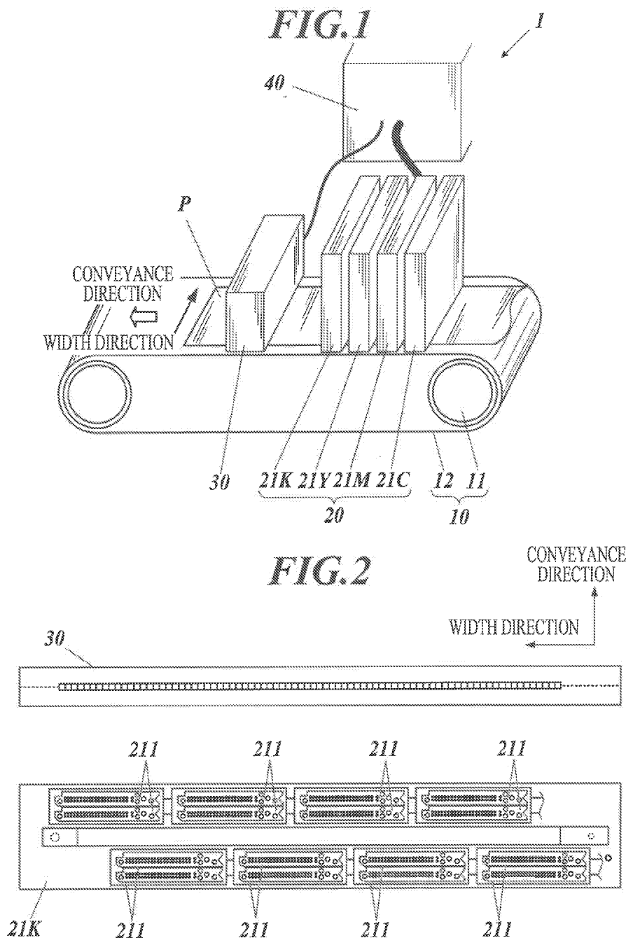

FIG. 2 schematically shows a positional relationship between nozzle opening parts on a surface of the head unit 21K and an imaging area on a surface of the image reader 30, the surfaces facing the conveyance surface.

The head units 21C, 21M, 21Y have the same configuration as the head unit 21K, and hence explanations thereof are omitted.

The head unit 21K has 16 discharge heads 211 in each of which the nozzle opening parts are arranged on the bottom at predetermined intervals (at nozzle intervals), for example, at about 42.3 μm intervals corresponding to 600 dpi (dot per inch). Two discharge heads 211 form a pair, and the nozzle opening parts of the discharge heads 211 are alternately arranged in the width direction, and accordingly, together, can form an image(s) with recording resolution of 1,200 dpi (a nozzle interval of about 21.2 μm). Such pairs of the discharge heads 211 are arranged in a houndstooth check, which constitutes a line head in which the nozzle opening parts are arranged at uniform intervals in the width direction so as to cover the recordable width. That is, the head unit 21K is fixed during image forming and successively discharges ink to different positions in the conveyance direction according to the conveyance of the recording medium P, thereby forming an image(s) with a single pass system.

The image reader 30 is configured, in this embodiment, such that the imaging elements are arranged to be able to obtain, as one-dimensional imaging data, data of imaging pixels (the data including pixel values of R, G and B of the imaging pixels) which are one-dimensionally arranged at equal intervals in the width direction so as to cover the recordable width. An arrangement interval of the imaging pixels is wider than the nozzle interval, and in this embodiment, about an interval of 42.3 to 45.4 μm corresponding to 560 to 600 ppi (pixel per inch). If the imaging pixels are arranged at 600 ppi, the recording resolution of a formed image(s) (i.e. the nozzle interval) is an integral multiple of the resolution of the imaging pixels, whereas if the imaging pixels are arranged at 560 ppi, 590 ppi or the like, the recording resolution thereof is a non-integral multiple of the resolution of the imaging pixels.

A plurality of line sensors in each of which imaging elements are one-dimensionally arranged in an area narrower than the recordable width may be arranged in a houndstooth check so as to, as a whole, cover the recordable width, thereby being able to read an image(s) at each point in the width direction corresponding to each imaging pixel. In FIG. 2, positions corresponding to the respective imaging pixels are represented by squares which are one-dimensionally arranged. The arrangement of the imaging elements which correspond to the imaging pixels and detect R, G and B, however, can be any well-known arrangement as far as the imaging elements as a whole can obtain an image(s) with resolution of 600 ppi or so, as described below.

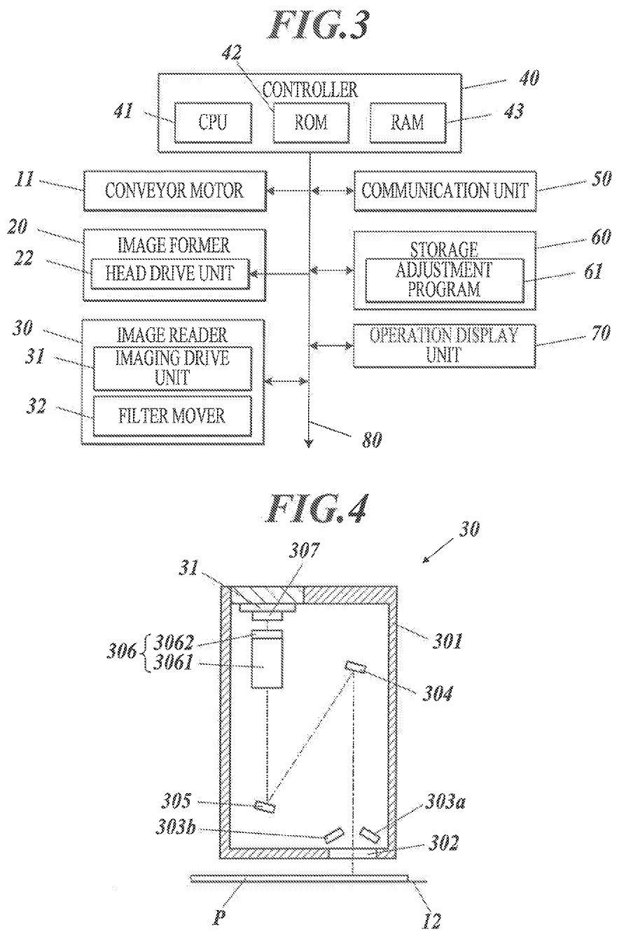

FIG. 3 is a block diagram showing functional configuration of the inkjet recording device 1 of this embodiment.

The inkjet recording device 1 includes the controller 40, the conveyor motor 11, a head drive unit 22, an imaging drive unit 31, a filter mover 32, a communication unit 50, a storage 60, an operation display unit 70 and a bus 80.

The controller 40 performs control operation of controlling the whole operation of the inkjet recording device 1. The controller 40 performs inspection and/or adjustment of mounting positions of the recording heads 211, state of ink discharge from each nozzle opening part, density distribution and so forth on the basis of a test image formed by the image former 20 and read by the image reader 30.

The controller 40 includes a CPU 41 (Central Processing Unit), a ROM 42 (Read Only Memory) and a RAM 43 (Random Access Memory). The CPU 41 performs various types of arithmetic processing, thereby performing processes for various types of control. The ROM 42 stores and saves control programs for the various types of control. As the ROM 42, a mask ROM or a readable-and-writable nonvolatile memory is used.

The RAM 43 provides the CPU 41 with a memory space for work, and stores temporary data and various settings. As the RAM 43, any volatile memory, such as an SRAM or a DRAM, is used.

The head drive unit 22 outputs drive signals for causing ink discharge mechanisms in the discharge heads 211 of the respective head units 21 to operate, so as to cause the head units 21 to discharge, at appropriate timings, the inks from the nozzle opening parts which are operation targets. These drive signals are output to the head units 21 (discharge heads 211) in parallel. Further, these drive signals are output in sync with a not-shown encoder which measures a conveyance speed (position) of the recording medium P being conveyed by the conveyor 10. As the ink discharge mechanism(s), a piezo system or a thermal system is used, for example. The piezo system is a system of applying voltage(s) to piezoelectric elements arranged along ink flow channels which communicate with nozzles. This deforms the piezoelectric elements and applies pressure(s) of a predetermined pressure pattern to ink in the ink flow channels, thereby discharging the ink. The thermal system is a system of electrifying heating wires to generate heat. This heats and partly vaporizes the ink in the ink flow channels, and accordingly causes volume change in the ink and applies pressure(s) to the ink, thereby discharging the ink.

The imaging drive unit 31 causes the image reader 30 to perform various types of operation for reading an image(s) on the recording medium P. The imaging drive unit 31 performs operation of causing the line sensor of a detector 307 (shown in FIG. 4) to operate to detect an incident light amount(s), generate imaging data from data on the detected incident light amount, and output the generated imaging data to the controller 40 (RAM 43) or the storage 60. The generated imaging data may be directly output to the RAM 43 or the storage 60 by DMA (Direct Memory Access) without control of the CPU 41. At the time of the conversion of the data on the incident light amount to the imaging data, predetermined calibration may be performed.

The filter mover 32, for example, switches optical low-pass filters 3062 (OLPF shown in FIG. 4) and/or adjusts the position of the OLPF(s) 3062 in order to obtain the resolution of a reading image(s) with an appropriate cutoff frequency when the image reader 30 reads the image on the recording medium P.

The communication unit 50 obtains data on images to be formed and print jobs, for example, from an external computer terminal or print server, and also outputs status signals for image forming.

The storage 60 stores: the data on images to be formed obtained via the communication unit 50; and their processed data, for example. The storage 60 also stores a program for controlling operation of the line sensor when the image reader 30 reads a predetermined test image and an adjustment program 61 for determining necessity of adjustment of the components of the inkjet head 1 and the adjustment amount(s) by calculating desired position information, density information and so forth from the imaging data on the test image. The storage 60 may also store various executable programs for image forming. At the time of execution of the executable programs, the CPU 41 reads and then loads the executable programs into the RAM 43 to use the programs. As the storage 60, an HDD (Hard Disk Drive) or a flash memory is used, or may be used in combination with a RAM or the like.

The operation display unit 70 displays a user input operation receiving screen and status information, and receives input operations from a user(s) and outputs operation signals to the controller 40. In this embodiment, the operation display unit 70 has, for example, a liquid crystal screen provided with a touch sensor(s) and its driver. Alternatively, for displaying, a display screen using another display system, such as an organic EL display, may be used, or an LED lamp for displaying the status and/or the like may also be used. Further, for receiving the operations, instead of or in addition to the touchscreen, a push button/switch, a rotary switch and/or the like may be provided.

The bus 80 is a path for the controller 40 and the other components to exchange signals.

Next, image reading in the inkjet recording device 1 of this embodiment is described in detail.

FIG. 4 schematically shows internal configuration of the image reader 30 of this embodiment.

FIG. 4 shows the configuration of the image reader 30 viewed from the front. The lower side of this figure is a direction where the recording medium P and the conveyor belt 12 which constitutes a placement surface for the recording medium P are provided.

The image reader 30 includes, in a light blocking case 301, light sources 303a, 303b, a first mirror 304, a second mirror 305, a lens optical unit 306 and the detector 307. At a part of the case 301, an entrance window from which outside light enters via a light transmissive cover member 302 is provided. The case 301 is arranged at a position and an orientation at which the entrance window faces the outer circumferential surface of the conveyor belt 12, namely, the surface of the recording medium P being conveyed.

The cover member 302 transmits light (visible light), and also prevents dust and ink mist from entering the case 301. The outer surface of the cover member 302 may be provided with an antifouling layer which prevents dust and so forth from adhering to the outer surface of the cover member 302, by being subjected to soil-resistant finish, dust-resistant finish and/or the like. As the cover member 302, a well-known transparent member which transmits visible light, such as a glass plate, is used.

The detector 307 has the line sensor described above. As the line sensor, for example, a CCD (Charge Coupled Device) sensor or a CMOS (Complementary Metal Oxide Semiconductor) sensor is used. The line sensor outputs electric charges and voltages corresponding to the incident light amounts on the respective imaging elements. As light receiving elements which generate the electric charges corresponding to the incident light amounts in the respective imaging elements, photodiodes or photocouplers are used, for example.

The line sensor herein can include a three-line line sensor in which imaging elements that detect R, G and B are arranged at different positions in the conveyance direction to be three lines parallel to one another. The line sensor may be a one-line line sensor in which element groups are repeatedly arranged in the width direction, wherein in each element group, imaging elements that detect R, G and B are arranged by turns in the width direction, or may be a line sensor (i) in which imaging elements that detect R, G and B are arranged to be two lines on the conveyance direction by Bayer arrangement and (ii) which obtains brightness values at the positions of respective imaging pixels on one line by combination of values detected by the imaging elements in predetermined adjacent areas. In the case of the three-line line sensor, for example, the line sensor can read the same position optically independently/separately by making detection timings of R, G and B different from one another according to the conveyance speed of the recording medium P by the conveyor 10. Similarly, in the case of the line sensor in which imaging elements that detect R, G and B are arranged to be two lines by Bayer arrangement, detection timings of the two lines may be made different from one another according to the conveyance speed.

The lens optical unit 306 has: one or more lenses 3061 each of which performs convergence and reduction imaging of the incident light (image) at the positions of the light receiving elements of the detector 307; and the optical low-pass filter 3062 (OLPF) which splits the incident light converged by the lens(es) 3061 such that the incident light enters the plurality of imaging elements; and so forth. The lens optical unit 306 may be provided with, in addition to the filter mover 32, an adjustment mechanism which changes, for example, the focal position of the lens(es) 3061.

The OLPF 3062 can be inserted onto and evacuated from an optical axis of the lens optical unit 306 according to operation of the filter mover 32. When an image is imaged, if the resolution in the width direction of the image as the imaging target does not need to be lowered, the filter mover 32 operates, on the basis of the control of the controller 40, to evacuate the OLPF 3062 from the optical axis. Meanwhile, if moire needs to be suppressed, for example, when a test image for calculating the position information is imaged, the filter mover 32 operates to insert the OLPF 3062 onto the optical axis. The OLPF 3062 is adjustable about the angle of inclination with respect to the optical axis and the position along the optical axis.

The light sources 303a, 303b illuminate a reading range on the recording medium P. The light sources 303a, 303b are arranged near the cover member 302 so as not to block an optical path (path of the incident light) from a reading surface to the detector 307. As the light sources 303a, 303b, various types of light sources, such as LEDs (Light Emitting Diodes) or organic light emitting diodes, can be used. These light sources 303a, 303b may be configured, as needed, such that their brightness can be changed, for example, in a predetermined number of levels. The light sources 303a, 303b emit light in the case 301. Hence, it is preferable that the inner surface of the cover member 302 be subjected to antireflection coating (AR coating) or the like to suppress reflection of the outgoing light from the light sources 303a, 303b.

The first mirror 304 and the second mirror 305 reflect and guide the light entered from the entrance window through the cover member 302 to the lens optical unit 306. Although the first mirror 304 and the second mirror 305 are plane mirrors in this embodiment, one or both of them may be a concave mirror(s) for condensing light, as needed.

The first mirror 304, the second mirror 305 and the lens optical unit 306 constitute an optical unit.

By having these components, the image reader 30 obtains imaging data corresponding to the incident light from a predetermined line extending in the width direction on the recording medium P by focusing on the surface of the recording medium P, the surface facing the area of the entrance window.

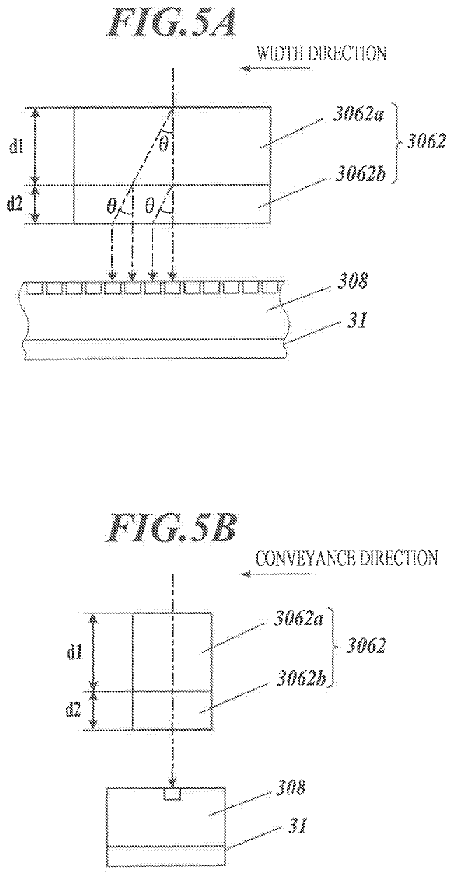

FIG. 5A and FIG. 5B are diagrams to explain configuration of the OLPF 3062.

Although the OLPF 3062 is not particularly limited, in this embodiment, flat crystal plates are used. The OLPF 3062 is configured such that two (a plurality of) flat crystal plates 3062a, 3062b different in thickness are laid on top of one another with a polarizing plate(s) and/or the like in between as needed and made to adhere to one another.

The flat crystal plates each perform birefringence on the incident light so as to split the incident light into an ordinary ray (normal ray) and an extraordinary ray by a predetermined angle difference θ. As a result, the ordinary ray and the extraordinary ray of the incident light entered from one incident position and split to be separated are, when exiting from the OLPF 3062, exit from positions different from one another by a distance L=d·tan(θ), the distance L depending on the thickness d of the flat crystal plate(s). This separation width between the exit positions of the ordinary ray and the extraordinary ray corresponds to a cutoff frequency (spatial cycle) which is relevant to decrease in the resolution of an imaging image(s), and from spatial distribution of the incident light in a direction in which the incident light is split, a spatial structure(s) on a higher frequency side than the cutoff frequency (high-frequency component) is removed.

As shown in FIG. 5A, both of the two flat crystal plates 3062a, 3062b separate the extraordinary ray from the ordinary ray in the width direction, thereby making the exit positions of the extraordinary ray different from the exit positions of the ordinary ray by a distance of d1·tan(θ) and a distance of d2·(θ) in the width direction, respectively, in accordance with their respective thicknesses d1 and d2. This makes the light exiting from the different exit positions incident on the imaging elements arranged in the width direction. It is preferable that the thicknesses of the flat crystal plates 3062a, 3062b of the OLPF 3062 be determined such that their shift widths of the exit positions are determined according to the arrangement interval of the imaging elements.

Meanwhile, as shown in FIG. 5B, the incident light on the OLPF 3062 is not split in the conveyance direction. Hence, the incident light entered from one incident position is, in the conveyance direction, exits from only one position.

In this embodiment, each of the two flat crystal plates 3062a, 3062b separates the ordinary ray and the extraordinary ray from one another with respect to the optical axis. These flat crystal plates 3062a, 3062b hold d1>d2, namely, are different in thickness. Hence, the incident light as a whole incident on a predetermine position is split in to four positions in the width direction. Among these four positions, shift amounts of three positions in the width direction from the exit position from which the entire incident light would have been output as the ordinary ray are a distance of d2·tan(θ), a distance of d1·tan(θ) and a distance of (d1+d2)·tan(θ), respectively. The split in to these four exit positions eliminates the high-frequency spatial structure from a reduced image at the positions of the light receiving elements, namely, at a reduction imaging position, and the image is detected by the imaging elements. Further, with respect to a dot(s), a line(s) and so forth each having a predetermined width, density thereof is dispersed in Gaussian distribution so as to gradually decrease in the width direction from the center of the dot, line or the like.

Meanwhile, at an orientation along the conveyance direction, the imaging element(s) is arranged at only one position, and the outgoing light not split into rays by the OLPF 3062 exits as it is to the imaging area of the imaging elements. In the line sensor, even if the extraordinary ray is separated in a direction perpendicular to an arrangement direction of the imaging elements, namely, in the conveyance direction, there is no imaging element which detects the separated extraordinary ray. As a result, decrease in the light amount is brought. Decrease in the light amount to be detected is prevented by the OLPF 3062 separating the extraordinary ray in the arrangement direction (width direction) only.

In the case of one flat crystal plate, a cyclic spatial structure(s) corresponding to a cutoff frequency near Nyquist frequency is removed. Hence, as described above, providing and laying thereon one more flat crystal plate having a cutoff frequency higher than the above (i.e. being thin and having a small separation width) on the line sensor side can output and detect an image(s) from which the cyclic spatial structure equal to or higher than the Nyquist frequency has been more certainly removed.

In this way, in the width direction, the resolution of the image formed by reduction imaging is lowered by spatially dispersing the light which enters the imaging area of the imaging elements. Preferably, the spatial resolution is lowered to ½ of the resolution of one-dimensional imaging data (i.e. Nyquist frequency) by the line sensor or lower. This prevents misrecognition in an image(s) caused by moire or the like. If the incident light amount is spatially dispersed, the peak value of the brightness values detected by the imaging elements imaging a line or the like decreases. Hence, light intensity of the light sources 303a, 303b may be increased, or detection time of the incident light by the imaging elements may be extended.

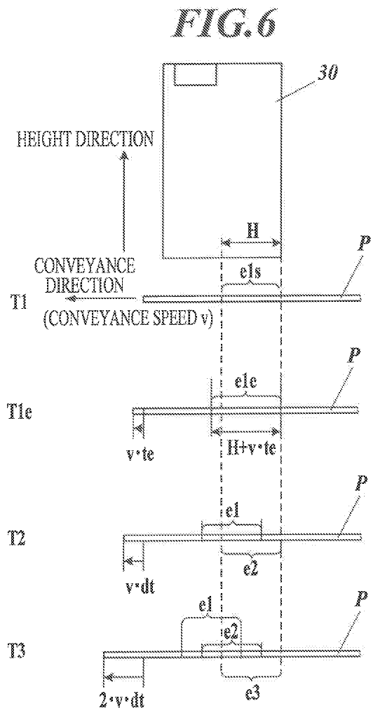

FIG. 6 shows a diagram to explain image reading in the conveyance direction.

If an image formed on the recording medium P being conveyed at a conveyance speed v (relative movement speed) is imaged at time intervals dt (scan rate), an imaging range e1 in the conveyance direction by each of the imagining elements of the image reader 30 moves a distance of v·dt between the first imaging timing T1 and the next imaging timing T2. The imaging range e1 moves a distance of 2·v·dt between the first imaging timing T1 and the third imaging timing T3.

An imaging range e2 at the next imaging timing T2 after one imaging is performed is located the distance of v·dt (relative movement distance in the time interval dt) from the previous imaging range e1 to the upstream side in the conveyance direction on the recording medium P. In this embodiment, the distance of v·dt is smaller than a width H of the imaging range e1 or e2 (length of the imaging range). Hence, the imaging ranges e1 and e2 adjacent to one another overlap one another in the conveyance direction. Similarly, an imaging range e3 at the third imaging timing T3 is located the distance of v·d from the previous imaging range e2 to the upstream side in the conveyance direction on the recording medium P. In this embodiment, the movement distance of 2·v·dt between the first imaging timing T1 and the third imaging timing T3 is smaller than the width H. Hence, the third imaging range e3 overlaps not only the second imaging range e2 but also the first imaging range e1.

If imaging time te (detection time of the incident light on the imaging elements) is not short enough to be ignored when compared with the time interval dt, (i) the width H corresponding to the imaging range e1 at the imaging timing T1 at which the first imaging starts plus (ii) a movement distance of v·te in the imaging time te, namely, by a timing T1e at which the first imaging finishes, is an imaging range e1e. In this case, the resolution of each imaging image is determined according to the total width of H+v·te. If this value is twice the original width H or larger, influence of moire is suppressed.

Thus, if imaging ranges of imaging performed at successive times overlap one another, in the conveyance direction, data detected by each imaging element is a value corresponding to the moving average of one imaging range moving in the conveyance direction. Consequently, a detected value in each imaging range e1, e2 or e3 is the resolution corresponding to the width H (H+v·te) of the imaging range, but the resolution as a whole is determined according to the movement distance of v·dt, and hence if the movement distance of v·dt is sufficiently smaller than the image's spatial structure (if the resolution as a whole increases), moire or the like does not appear. Hence, the trend of change of the detected values obtained by performing imaging multiple times is obtained more accurately. As a result, by weighted averaging or the like of the detected values obtained without detection loss of the light amount thanks to the direction-dependent OLPF 3062, positions of dots, lines or the like as detection targets on an image as the imaging target, in particular, a test image (predetermined test image) for inspecting and adjusting the state of ink discharge, the mounting positions of the head units and so forth, are obtained with higher accuracy than the width of each imaging range. The process for obtaining (calculating) the position information is performed by the CPU 41 of the controller 40 on the basis of the imaging data on the test image.

The inkjet recording device 1 of this embodiment makes the distance of v·dt as a shift amount between the imaging ranges adjacent to one another in the conveyance direction small, and also, in order to ensure output time of the detected values from the line sensor(s), arithmetic processing time based on the detected values and so forth and/or in order to extend the imaging time te by the line sensor to increase the light amount to be detected, when forming and reading a test image, makes the conveyance speed v lower than when forming an ordinary output image (ordinary image) other than the test image.

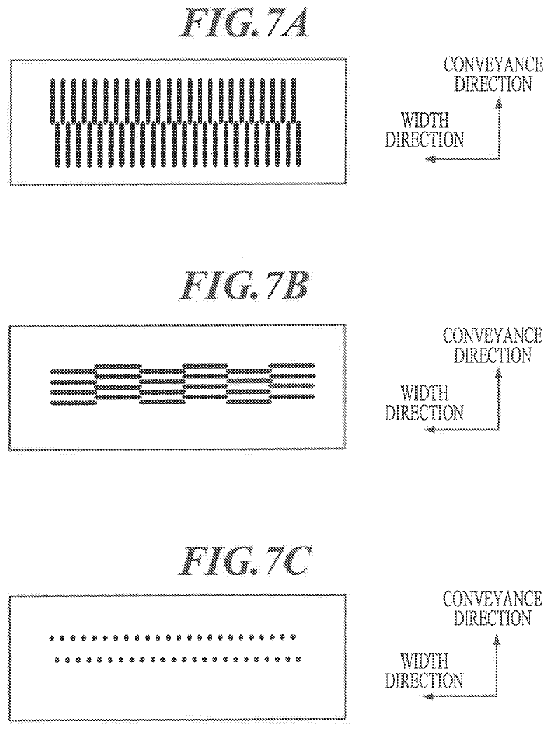

FIG. 7A to FIG. 7C each show a part of an example of the test image which is used in the inkjet recording device 1 of this embodiment.

To detect the positions of the recording heads 211 in the width direction, for example, as shown in FIG. 7A, line segments extending in the conveyance direction are formed with ink which is discharged from the nozzles while the discharge positions are adjusted in the conveyance direction such that ranges of discharge from the nozzles do not overlap one another. In this case, accuracy of the position information in the width direction is important, whereas accuracy of the position information in the conveyance direction is not important because as the positions in the conveyance direction, lengths of the line segments or so are enough. Hence, the decrease width of the conveyance speed v is small or may be zero. A recorded image the resolution in the width direction of which has been decreased by the OLPF 3062 is input to the line sensor so that moire does not appear, and also from distribution of the brightness values of the imaging elements, the position information as a whole is obtained with higher accuracy than the resolution.

To detect the positions of the recording heads 211 in the conveyance direction, for example, as shown in FIG. 7B, while timings of ink discharge from the nozzles of the respective recording heads 211 are made different from one another as needed, ink is discharged from the nozzles of the same recording head 211 all at once in a short range in the conveyance direction. In this case, the positions in the conveyance direction are important, whereas the positions in the width direction and presence or absence of moire are not so important. Hence, the conveyance speed v is greatly decreased, and in the conveyance direction, the resolution as a whole is increased. At the time, the OLPF 3062 may be used or not.

To determine the positions of the nozzles in the width direction and the conveyance direction at once, namely, to determine whether or not ink lands at desired positions on an image at once, for example, as shown in FIG. 7C, an image of dots is formed, and both the position information in the width direction and the position information in the conveyance direction need to be obtained with high accuracy. At the time, the conveyance speed v is greatly decreased so that in the conveyance direction, the resolution of the position information as a whole is increased, and in the width direction, the resolution is decreased by the OLPF 3062 so that appearance of moire is prevented, and also from the brightness values of the imaging elements, the position information with high accuracy is obtained.

Preferably, these test images are each formed for each of C, M, Y and K individually.

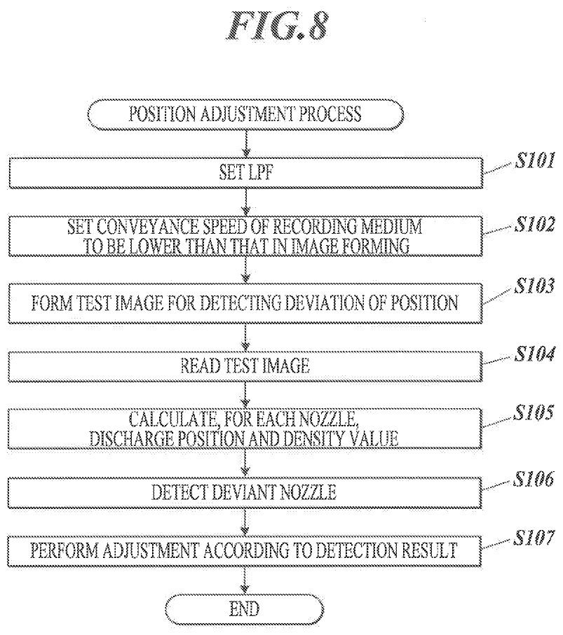

FIG. 8 is a flowchart showing a control procedure of a position adjustment process by the controller 40.

The position adjustment process is a process for detecting, with respect to all of the nozzles and/or each of the nozzles of each head unit 21, an ink discharge amount(s) and presence or absence of deviation of the discharge position(s) from the normal position(s), and adjusting the ink discharge amount(s) and the discharge position(s). This process is automatically called and performed (i) at the time of startup of the inkjet recording device 1, (ii) for every predetermined number of images formed, or (iii) at the time when another predetermined condition is satisfied.

When the position adjustment process is started, the controller 40 (CPU 41) outputs a control signal to the filter mover 32 to set the OLPF 3062 to function in the width direction (Step S101). Further, the controller 40 sets the conveyance speed of the conveyor belt 12 by the conveyor motor 11 to be lower than that in forming an ordinary image(s) (Step S102).

The controller 40 causes the head units 21 to form, on the recording medium P, a test image for detecting deviation of the ink discharge positions (Step S103). The test image to be formed in this step is, for example, the one shown in FIG. 7A. The controller 40 causes the image reader 30 to read the formed test image at predetermined intervals, namely, every time the recording medium P is moved a predetermined distance in the conveyance direction (Step S104).

The controller 40 reads positions of line segments formed by using the nozzles and densities of the line segments (Step S105). Each line segment to be read in this step is detected over a plurality of reading pixels owing to the OLPF 3062. Hence, by obtaining the barycentric position and the volume of distribution of these, the position and the density of the line segment are obtained.

The controller 40 searches the calculated positions and densities of the line segments for values outside normal values, thereby detecting a deviant nozzle(s) or head unit(s) 21, which deviates in the position(s) (Step S106). The controller 40 performs adjustment thereof according to the detection result (Step S107). The controller 40 causes the detected deviant nozzle to stop discharging ink, and changes a setting(s) to cause the nozzle to discharge ink to an appropriate position. If such setting change hardly forms images having a desired image quality, for example, if the nozzles of the head unit(s) 21 as a whole or the nozzles continuous in the width direction deviate in the positions, the controller 40 causes a not-shown cleaning unit to clean an ink discharge surface(s) of the head unit(s) 21, and/or causes the head units 21 to stop forming images and the operation display unit 70 to perform predetermined notification. Then, the controller 40 finishes the position adjustment process.

As described above, the inkjet recording device 1 of this embodiment includes: the image former 20 which discharges ink from the nozzle(s), thereby forming an image on the recording medium P; the image reader 30 which images the surface of the recording medium P; and the conveyor 10 which moves at least one of the recording medium P and the image reader 30, the recording medium P in the above embodiment, thereby relatively moving the recoding medium P and the image reader 30 in a predetermined relative movement direction, wherein the image reader 30 includes: the detector 307 having the line sensor which has the plurality of imaging elements, and detects incident light from the surface of the recording medium P over an imaging range corresponding to arrangement of the imaging elements in the width direction intersecting the relative movement direction (conveyance direction) (at right angles), thereby performing one-dimensional imaging along the width direction; and the lens optical unit 306 which removes a high-frequency-side component that is a spatial structure equal to or higher than a predetermined cutoff frequency from spatial distribution of the incident light from the imaging range for the line sensor and guides the incident light to the line sensor, and the cutoff frequency for the high-frequency-side component which is removed by the lens optical unit 306 is determined to be lower in the width direction than the conveyance direction.

The inkjet recording device 1 does not always need to image the whole formed image with high quality, but should be able to obtain, when reading necessary information from a test image for inspection of a formed image, in particular, for adjustment of the state of ink discharge and the head units 21, information, for example, on the positions and/or the densities with necessary resolution. At the time, artificial patterns, such as moire, prevent the necessary information from being obtained. Hence, the image reader 30 can read a formed image by the image former 20 by reducing the resolution thereof in the width direction to the resolution corresponding to the resolution of the line sensor of the image reader 30. Further, by generating the density distribution over a plurality of imaging pixels, even if the resolution is low in units of the imaging pixels, the necessary information can be obtained by increasing accuracy of only the necessary information by various processes using the data of the plurality of imaging pixels. Meanwhile, the line sensor does not obtain data of a plurality of imaging pixels in the conveyance direction simultaneously. Hence, if the incident light is dispersed in the conveyance direction, this leads to loss of the incident light amount, and does not affect appearance of moire or the like. Further, in the conveyance direction, data obtaining density can be increased by the conveyance speed or imaging frequency. Hence, it is unnecessary to decrease the resolution for the data of each imaging pixel. That is, the inkjet recording device 1 can obtain usually necessary information read from an image(s) without using an expensive line sensor.

Thus, the inkjet recording device 1 can obtain imaging data with more appropriate resolution in each of the conveyance direction and the width direction.

Further, the lens optical unit 306 removes the high-frequency-side component at an orientation along the width direction only. Hence, in the width direction, the image resolution is made to correspond to the detection resolution so that the problems, such as moire, do not arise, whereas in the conveyance direction, the incident light is not split in to outside a region(s) detected by the imaging elements, and accordingly the light amount to be detected is not reduced or an image is not blurred. This allows the detector 307 to read an appropriate image which can appropriately prevent misidentification of the recorded positions (ink landing positions) corresponding to the respective nozzles.

Further, the cutoff frequency in the width direction is equal to or lower than the Nyquist frequency corresponding to the resolution of one-dimensional imaging data by the line sensor, namely, the arrangement interval of the imaging pixels. This eliminates a possibility of appearance of moire.

Further, the lens optical unit 306 includes the OLPF 3062 which removes the high-frequency-side component. This eliminates a need to make the focal configuration of the lens 3061 intricate, and also enables easy attachment/detachment, adjustment and replacement of the OLPF 3062, and allows the detector 307 to easily and appropriately read an image having preferable resolution.

Further, the OLPF 3062 is configured such that the flat crystal plates each of which performs birefringence on the incident light in the width direction are laid on top of one another. This splits the incident light in the width direction with an appropriate amount of dispersion, and allows the detector 307 to read an image having appropriate resolution.

Further, the separation width between the ordinary ray and the extraordinary ray of at least one of the flat crystal plates (one of two in the above embodiment) is different from the separation width of another/the other flat crystal plate(s). This makes it possible to finely determine the resolution with respect to a plurality of separation widths, and allows the detector 307 to read an image having appropriate resolution.

Further, in the OLPF 3062, the separation width between the ordinary ray and the extraordinary ray of, among the flat crystal plates, a flat crystal plate closest to the line sensor is smaller than the separation width of the remaining flat crystal plate(s). This can more certainly remove the high-frequency-side spatial structure component, which remains (is generated) because a structure(s) near the cutoff frequency is removed first owing to characteristics of an OLPF constituted of flat crystal plates.

Further, the separation width by the OLPF 3062 is determined according to the arrangement interval of the imaging elements in the width direction. This appropriately allots the separated ordinary ray and extraordinary ray to the imaging elements and makes them incident thereon, and accordingly allows the detector 307 to detect an image having appropriate resolution.

Further, the resolution (e.g. 560 ppi) of one-dimensional imaging data by the line sensor is determined to be smaller than the recording resolution (e.g. 1,200 dpi) corresponding to the nozzle interval of the nozzles in the width direction in each head unit 21 of the image former 20, and the recording resolution is determined to be a non-integral multiple of the resolution of the one-dimensional imaging data. Consequently, if the OLPF 3062 is not used and the detector 307 reads an image, moire is likely to appear in the image. Converting such an image to an image having appropriate resolution in the width direction can prevent moire from appearing without decreasing accuracy more than necessary and can read the image.

Further, the controller 40 as the movement control unit which controls the movement speed (conveyance speed) of the recording medium P by the conveyor 10 is provided, wherein the controller 40 makes the conveyance speed lower in imaging a predetermined test image with the image reader 30 than in forming an ordinary image. This makes it possible to read an image in the conveyance direction at fine position steps, and accordingly identify positions in the conveyance direction of desired ink landing positions on a test image with high accuracy. In particular, because of the decrease in the conveyance speed, reading frequency of lines by the image reader 30 does not need to be forcibly increased, and accordingly processing speed of imaging data does not need to be increased more than necessary, and therefore increase in cost and size due to higher functionality can be suppressed. Alternatively, detection time of the light by the imaging elements may be extended for the decrease in the movement speed to increase the amount of the light to be received and to improve S/N ratio, thereby increasing reading accuracy of an image(s).

Further, the controller 40 as the position information obtaining unit obtains, on the basis of the imaging data on the test image, the position information on a position(s) at which the ink discharged from the nozzle(s) lands on the recording medium P.

More specifically, as described above, by preventing moire from appearing without decreasing the resolution more than necessary, thereby reading an image having appropriate resolution in each of the width direction and the conveyance direction, even if the resolution of the line sensor is lower than the resolution of an image formable by the head units 21, the ink landing positions can be calculated more accurately than before. This enables more highly accurate and more certain adjustment of the inkjet recording device 1 while suppressing cost increase from the conventional configuration.

Further, the controller 40 as the movement control unit sets the conveyance speed v such that the relative movement distance of v·dt of the image reader 30 and the recoding medium P in the interval dt between times at which the line sensor performs imaging is smaller than the width H of the imaging range in the conveyance direction by each of the imaging elements of the line sensor.

This allows the line sensor to read an image with the same range on the recording medium P being partly duplicated in the conveyance direction. Consequently, as compared with the resolution of an image, more imaging data than the number of the pixels are obtained. Hence, even if the resolution of the data detected by each imaging element is low, by appropriately processing the data detected by the respective imaging elements, the position information corresponding to higher resolution can be obtained with accuracy.

Further, the controller 40 as the filter control unit, when causing the image reader 30 to image a test image having a spatial structure cycle smaller than the arrangement interval of the imaging elements of the line sensor in the width direction, causes the OLPF 3062 to remove the predetermined high-frequency-side spatial structure from the spatial distribution of the incident light. That is, if an image to be read does not have resolution equal to or higher than the resolution of the line sensor, for example, the OLPF 3062 is taken away from on the optical axis not to be used and not to unnecessarily blur the image.

The present invention is not limited to the above embodiment and can be modified in a variety of aspects.

For example, in the above embodiment, the inkjet recording device 1 uses the line heads (i) in each of which the nozzles are arranged in the width direction so as to cover the image recordable width of the recording medium P, and (ii) each of which discharges ink with its position fixed. However, the image former is not limited to the line head(s), and may be one which discharges ink while performing scanning, thereby recording images on recording media.

Further, the arrangement of the nozzles, the number and arrangement of the recording heads and so forth can be determined appropriately.

Further, in the above embodiment, the image reader 30 (line sensor) which is fixed with respect to the recording medium P which is moved in the conveyance direction reads an image(s) on the recording medium P. Alternatively, the image reader 30 may be moved in a predetermined direction while the recording medium P is fixed, or both the image reader 30 and the recording medium P may be moved along predetermined relative movement directions.

Further, in the above embodiment, the flat crystal plates are used to separate the ordinary ray and the extraordinary ray from one another to decrease the resolution of a reading image(s). However, how to decrease the resolution of a reading image(s) is not limited thereto. For example, a lens unit the focal position of which is different between the conveyance direction and the width direction may be provided, and an image blurred in the width direction by being in focus in the conveyance direction may be made incident on the imaging elements of the line sensor.

Further, in the above embodiment, the OLPF 3062 is constituted of two flat crystal plates having different thicknesses being laid on top of one another, but may be constituted of one flat crystal plate or three flat crystal plates, or may be constituted of flat crystal plates having the same thickness.

Further, in the above embodiment, the resolution in the conveyance direction is not decreased. However, for example, depending on the size of light receiving pixels of the imaging elements and/or design of the OLPF 3062, the resolution in the conveyance direction may be decreased within a range not lower than the resolution in the width direction.

Further, in the above embodiment, the line sensor performs imaging with imaging ranges being overlapped in the conveyance direction. Alternatively, the line sensor may perform this operation each time the recording medium P is conveyed a distance equal to one imaging range in the conveyance direction, or may perform imaging intermittently with a gap generated between the imaging ranges in the conveyance direction, for example, if the position information in the conveyance direction is unnecessary or does not need to be highly accurate.

Further, in the above embodiment, with respect to the incident light corresponding to the square imaging pixels, only the resolution in the width direction is limited by the OLPF 3062. Alternatively, it is possible that the width H in the conveyance direction is reduced (narrowed) in advance, and the resolution in the conveyance direction is determined from a magnitude relationship between the movement distance of v·dt in the interval of imaging and the width H so that the resolution in the conveyance direction can be set up to higher one, whereas the resolution in the width direction is decreased as needed. This can adjust the resolution of imaging data to more appropriate resolution without changing the number of the imaging elements or their arrangement density.

Further, in the above embodiment, the OLPF 3062 is moved to decrease the resolution selectively. Alternatively, the OLPF 3062 may be fixed, or may be integrated with the lens 3061.

In addition to the above, the specific details of the components, arrangements, operation procedures and so forth described in the above embodiment can be appropriately modified without departing from the scope of the present invention.

### INDUSTRIAL APPLICABILITY

The present invention is applicable to an inkjet recording device.

### DESCRIPTION OF REFERENCE NUMERALS

1 Inkjet Recording Device
10 Conveyor
11 Conveyor Motor
12 Conveyor Belt
20 Image Former
21, 21C, 21M, 21Y, 21K Head Unit
211 Discharge Head
22 Head Drive Unit
30 Image Reader
301 Case
302 Cover Member
303a, 303b Light Source
304 First Mirror
305 Second Mirror
306 Lens Optical Unit
307 Detector
3061 Lens
3062 Optical Low-Pass Filter (OLPF)
3062a, 3062b Flat Crystal Plate
31 Imaging Drive Unit
32 Filter Mover
40 Controller
41 CPU
42 ROM
43 RAM
50 Communication Unit
60 Storage
61 Adjustment Program
70 Operation Display Unit
80 Bus
e1 to e3, e1e Imaging Range
P Recording Medium
v Conveyance Speed

1. An inkjet recording device comprising:
an image former which discharges ink from a nozzle, thereby forming an image on a recording medium;
an image reader which images a surface of the recording medium; and
a conveyor which moves at least one of the recording medium and the image reader, thereby relatively moving the recoding medium and the image reader in a predetermined relative movement direction, wherein
the image reader includes:
a line sensor which has a plurality of imaging elements, and detects incident light from the surface of the recording medium over an imaging range corresponding to arrangement of the imaging elements in a width direction intersecting the relative movement direction, thereby performing one-dimensional imaging along the width direction; and
an optical unit which removes a high-frequency-side component that is a spatial structure equal to or higher than a predetermined cutoff frequency from spatial distribution of the incident light from the imaging range and guides the incident light to the line sensor, and
the cutoff frequency for the high-frequency-side component which is removed by the optical unit is determined to be lower in the width direction than the relative movement direction.

2. The inkjet recording device according to claim 1, wherein the optical unit removes the high-frequency-side component at an orientation along the width direction only.

3. The inkjet recording device according to claim 1, wherein the cutoff frequency in the width direction is equal to or lower than a Nyquist frequency corresponding to resolution of one-dimensional imaging data by the line sensor.

4. The inkjet recording device according to claim 1, wherein the optical unit includes an optical low-pass filter which removes the high-frequency-side component.

5. The inkjet recording device according to claim 4, wherein the optical low-pass filter is configured such that flat crystal plates each of which performs birefringence on the incident light in the width direction are laid on top of one another.

6. The inkjet recording device according to claim 5, wherein a separation width between an ordinary ray and an extraordinary ray of at least one of the flat crystal plates is different from the separation width of at least another one of the flat crystal plates.

7. The inkjet recording device according to claim 5, wherein in the optical low-pass filter, a separation width between an ordinary ray and an extraordinary ray of, among the flat crystal plates, a flat crystal plate closest to the line sensor is smaller than the separation width of a remaining flat crystal plate.

8. The inkjet recording device according to claim 6, wherein the separation width is determined according to an arrangement interval of the imaging elements in the width direction.

9. The inkjet recording device according to claim 1, wherein resolution of one-dimensional imaging data by the line sensor is determined to be smaller than recording resolution corresponding to a nozzle interval of nozzles including the nozzle in the width direction in the image former, and the recording resolution is determined to be a non-integral multiple of the resolution of the one-dimensional imaging data.

10. The inkjet recording device according to claim 1, comprising a hardware processor which controls a relative movement speed of the relative movement by the conveyor, wherein
the hardware processor makes the relative movement speed lower in imaging a predetermined test image with the image reader than in forming an ordinary image.

11. The inkjet recording device according to claim 10, wherein the hardware processor obtains, based on imaging data on the test image, position information on a position at which the ink discharged from the nozzle lands on the recording medium.

12. The inkjet recording device according to claim 11, wherein the hardware processor sets the relative movement speed such that a relative movement distance of the image reader and the recoding medium in an interval between times at which the line sensor performs imaging is smaller than a length of the imaging range in the relative movement direction by each of the imaging elements of the line sensor.

13. The inkjet recording device according to claim 4, comprising a hardware processor which, when causing the image reader to image a test image having a spatial structure cycle smaller than an arrangement interval of the imaging elements of the line sensor in the width direction, causes the optical low-pass filter to remove the high-frequency-side component from the spatial distribution of the incident light.
